(19) United States
(12) Patent Application Publication
(10) Pub. No.: US 2002/0142220 A1
(43) Pub. Date: Oct. 3, 2002

(54) Electrical cell including elemental iron and magnesium

(76) Inventor: Stephen R. Thomas, Great Bend, KS (US)

Correspondence Address: HOVEY WILLIAMS TIMMONS & COLLINS, 2405 GRAND BLVD., SUITE 400, KANSAS CITY, MO, 64108

(21) Appl. No.: 10/159,673

(22) Filed: May 29, 2002

Related U.S. Application Data
(63) Continuation of application No. 09/630,860, filed on Aug. 2, 2000.

(51) Int. Cl. H01M 4/38; H01M 6/36; H01M 4/66; H01M 4/62; H01M 4/60; H01M 4/42; H01M 4/46

(52) U.S. Cl. 429/221; 429/231.6; 429/112; 429/229; 429/245; 429/232; 429/213; 429/50; 429/176

(57) ABSTRACT

An electrical cell or battery (10, 44, 62) is provided which employs an elemental metal composition including quantities of elemental magnesium and elemental iron, together with electrodes (36, 38, 52, 60, 80, 82) operatively coupled with the metal composition. The current-generating composition also includes a minor amount of an alkali metal salt such as sodium chloride, and variable amounts of water. The metal fraction of the composition preferably includes from about 30-90% by weight elemental magnesium and from about 10-70% by weight elemental iron.

### RELATED APPLICATION

This is a continuation of U.S. application Ser. No. 09/630,860 filed Aug. 2, 2000.

### BACKGROUND OF THE INVENTION

1. Field of the Invention

The present invention is broadly concerned with electrical cells or batteries which include a current-generating composition made up of a metal fraction including respective quantities of elemental magnesium and elemental iron, together with an alkali metal salt and variable quantities of water. More particularly, the invention is concerned with such cells, and methods of generating current, wherein the cells can be of varied configuration and preferably make use of essentially “waste” elemental metals.

2. Description of the Prior Art

Electrical cells of varying complexity and utility have been in use for many decades. A constant problem with these cells is the weight and/or bulkiness thereof, versus the usable current produced thereby. That is, the storage batteries necessary to power an electrical car for example are generally very large and heavy, and require frequent recharging. Moreover, these batteries are expensive to produce. Similar issues are presented with other high current batteries used for other purposes.

Many metal-working operations such as machine shops and manufacturing facilities generate large volumes of metal dust. Disposal of these dusts can be a problem, owing to environmental concerns. That is, the time-honored practice of simply dumping such products in a landfill is often no longer permitted. Therefore, parties which create metal dusts or powders as a byproduct of manufacturing or the like face an increasingly difficult task of environmentally acceptable disposal.

### SUMMARY OF THE INVENTION

The present invention overcomes the problems outlined above and provides electrical cells or batteries having very high efficiencies, in terms of current output versus cost and weight. Broadly speaking, the cells of the invention comprise an elemental metal composition with a pair of spaced apart electrodes operably coupled with the composition for generation of electrical current. This composition includes a metal fraction having respective quantities of elemental magnesium and elemental iron, together with an alkali metal salt (e.g., sodium or potassium chloride) and water.

In preferred forms, the metal fraction is made up of particulate elemental magnesium and particulate elemental iron. There is effectively no lower limit on the size of such particles, but 400 mesh particles up to small chips may be employed. Inasmuch as foundry or mill dust from grinding or milling operations is readily available, such dusts are especially preferred. These products typically have an average particle size approximately that of the corresponding pyrotechnic particles, ±50%.

In preparative procedures, the elemental metal is ball milled together to achieve the lowest practical average particle size. Such metal particles are then mixed with the alkali metal salt and, if desired, liquid water. The compositions are then typically housed within an appropriate container, and the electrodes are coupled with the composition.

In the embodiment illustrated in FIG. 1, the cell comprises an upright, open top cylindrical container with two separate sections separated by a water permeable barrier. Preferred barriers are permeable in only a single direction, e.g. from one of the sections to the other but not in the reverse direction. An elemental metal composition is then pressed into two separate bodies and a carbon plate is attached to each of these bodies. Each of the combined compressed metal composition bodies is then suspended from a wire depending from the top of the container such that one metal composition body is contained in each of the respective container sections separated by the barrier. Wire electrodes are then operatively coupled to the carbon portions of the bodies and passed through openings in the sides of the container where they can be connected to a load.

In the use of this embodiment, an effective amount of water is added into the section of the container which will permit the flow of water through the barrier to the other side. Preferably the container is provided with a mark which signifies the appropriate water level for the cell. The addition of water begins an exothermic chemical reaction between the water and the compressed metal composition body, thereby heating the water. This heated water then permeates across the barrier into the other section of the container. Once this water reaches the metal composition body in the other section, an electrical current which can power a load is generated.

In the embodiment illustrated in FIGS. 2 and 3, the cell is a self contained, compact, portable device which can be used alone or placed in series with other cells. This embodiment includes a non-conductive casing presenting a central recess. This recess is lined with a layer of aluminum foil which is also secured to the casing of the device. The recess is adapted to hold a quantity of a particulate metal composition such that the composition is in contact with the foil layer. An electrically conductive wire projects from the casing and is in electrical contact with the foil layer, thereby acting as an electrode for the cell. To assist in retaining the metal composition in the recess, an iodine-impregnated, thin polyaniline sheet is disposed over the metal composition. Next, a layer of hygroscopic synthetic resin powder is placed over the polyaniline sheet. The cell construction is completed by applying a second layer of aluminum foil to the polyaniline sheet.

In the use of this embodiment, electrical leads are operatively connected to the wire and the exterior face of the foil layer. Current is generated when these leads are coupled to a load.

Another embodiment is illustrated in FIG. 4. For this embodiment, a box-like container having a central, unidirectional water permeable barrier which divides the container into two adjacent sections. A quantity of the elemental metal composition is placed into each respective container sections before embedding electrodes into each respective quantity of metal composition. These electrodes are secured in place by conductive clips which include wires extending therefrom. The wires are then coupled to a load. A preferred set of electrodes includes one electrode in the form of a ⅛″ diameter aluminum tube, while the other electrode is a sheet of commercially available pitch-based carbon fiber.

The embodiment illustrated in FIGS. 5 and 6 is similar in construction to the embodiment illustrated in FIGS. 2 and 3. In this embodiment, an electrically conductive layer, preferably aluminum foil, surrounds the cell. In the embodiment of FIG. 5, the cell includes a layer of the particulate metal composition, followed by a layer of water-absorbing and retaining polymer which is used to provide moisture to the metal composition. This layer is not included in the FIG. 6 embodiment. Therefore the metal composition remains substantially dry. Alternatively, water, or any other electrolytic fluid may be injected into the metal composition through ports passing through the foil layer. Next the anode is placed against the polymer layer followed by respective layers of carbon dust, each of which is separated by a layer of polyaniline or mylar plastic doped with I₂ crystals, a layer of copper oxide, or a layer of yttrium barium oxide. Alternatively, the mylar plastic can be used with or without a metal coating and the polyaniline can be doped with other suitable metals. The embodiment of FIG. 5 illustrates one possible arrangement of these successive layers while the embodiment of FIG. 6 illustrates another potential arrangement. In FIG. 5, the layers are arranged from the anode to the cathode in the following order: carbon dust-polyaniline-carbon dust- copper oxide- carbon dust- polyaniline- carbon dust- yttrium barium oxide- carbon dust- polyaniline- carbon dust- polyaniline- carbon dust. As the possible arrangement of the layers is not limited, another possible arrangement is provided in FIG. 6. These layers are arranged in the following order from the anode to the cathode: carbon dust-polyaniline-carbon dust- copper oxide- carbon dust- yttrium barium oxide- carbon dust- copper oxide- carbon dust- yttrium barium oxide- carbon dust- polyaniline- carbon dust.

Finally, the embodiment illustrated in FIG. 7 includes an insulative plastic housing surrounding a thin layer of electrically conductive material. A layer of moisture absorbing polymer is disposed within the enclosed layer of electrically conductive material, thereby separating the cell into a top layer and a bottom layer. The top layer includes an electrode connected to the layer of electrically conductive material followed by a layer of carbon powder or graphite which acts as an electron collector. This layer is followed by a layer of the previously described particulate metal composition which is disposed between the polymer layer and the carbon powder or graphite layer. The bottom layer is identical in construction, that is an electrode connected to a layer of electrically conductive material followed by a layer of carbon or graphite, followed by a layer of the particulate metal composition which lies adjacent the polymer.

Preferred moisture-absorbing polymers, such as those used in the embodiment illustrated in FIGS. 5-7, include sodium or potassium based cross-linked polymers, preferably Stockosorb AGRO or Stockosorb AGRO F (Both available from Stockhausen, Greensboro, N.C.). These polymers typically absorb water, thereby keeping the cell's powder moist. Preferably, these polymers have essentially neutral pHs and break down into environmentally inert elements and compounds, thereby contributing to the invention's breakdown into non-toxic byproducts.

It is believed that when different metals are immersed in the aqueous solution, they will experience different rates of dissolution into the liquid. As a result of this chemically-based process, a difference in voltage potential occurs due to the metal's positivity or negativity, relative to one another. In this situation, the electrons of the metals do not remain in fixed orbits about any one nucleus. Rather, they flow freely about a number of nuclei in a process commonly known as metallic bonding, and thereby easily permitting electric current to pass through the metals and the solution. Thus, the powder consists of an infinite number of particles, each of which act as a tiny battery which discharges and creates heat and generates hydrogen gas and magnesium hydroxide as byproducts. Simply put, the process involves the high-speed leaching of these freely flowing electrons. Advantageously, the cells of the present invention can be recharged by connecting them to a battery charger or by the addition of water to the cell. During this re-charging, electrons are re-deposited into orbits about specific nuclei or in a metallic bonding fashion. Thus, the same cell can be used repeatedly, further diminishing the waste potential of the cell.

### BRIEF DESCRIPTION OF THE DRAWINGS

FIG. 1 is a schematic sectional view of an electrical cell in accordance with the invention;

FIG. 2 is a sectional view of another type of cell in accordance with the invention;

FIG. 3 is a plan view of the cell depicted in FIG. 2;

FIG. 4 is a schematic sectional view of a still further type of electrical cell in accordance with the invention;

FIG. 5 is a schematic sectional view of a still further type of electrical cell in accordance with the invention;

FIG. 6 is a schematic sectional view of a still further type of electrical cell in accordance with the invention; and

FIG. 7 is a sectional view of yet another cell in accordance with the present invention.

### DETAILED DESCRIPTION OF THE PREFERRED EMBODIMENT

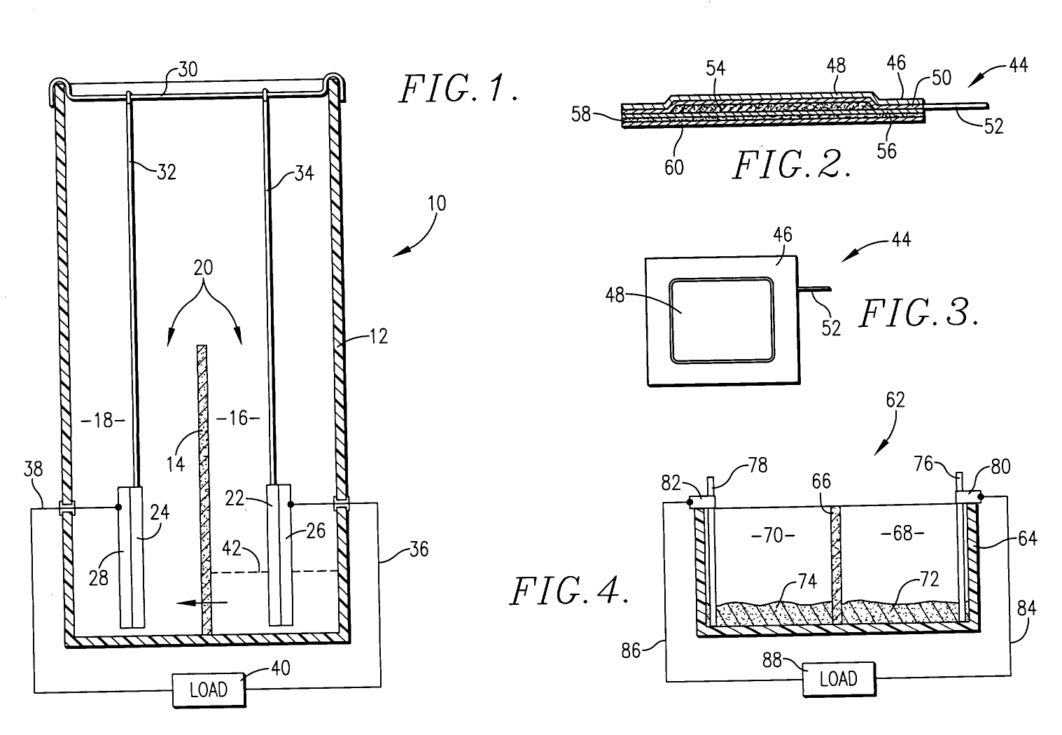

The electrical cells of the invention can take a variety of forms, depending upon desired end uses and current-generating capacities. To give but one example, a cell 10 illustrated in FIG. 1 includes an upright, open top cylindrical container 12 having a central, water-permeable barrier 14 therein dividing the container into adjacent, side-by-side sections 16 and 18. The barrier 14 is preferably formed of POREX porous synthetic resin (polytetrafluoroethylene) sheet material which is commercially available. The POREX is designed to permit permeation of water in one direction, while inhibiting water passage in the opposite direction. The overall cell 10 also includes an elemental metal composition 20, in this case split into two compressed bodies 22 and 24 formed of the composition. In particular, each body 22, 24 was formed by placing a quantity of particulate metal composition into a porous synthetic resin bag, and pressing the bagged composition in a manual vice until the composite became self-sustaining. In this instance, each such body was approximately 3″ long, ½″ wide and ¼″ thick. A segment of carbon plate 26, 28 was glued to a respective body 22, 24, with the plate segments having dimensions substantially equal to that of the bodies.

The bodies 22, 24 were suspended so that the body 22 was housed within container section 18 while body 24 was housed within section 16. In particular, a suspension wire 30 was placed across the open top of container 12, and corresponding hair wires 32, 34 were hung from the wire 30 in order to support the bodies 22, 24 as shown.

The cell 10 is completed by provision of wire electrodes 36, 38 which are operatively coupled to the carbon segments 26, 28 associated with the bodies 22, 24. As illustrated, the electrodes 36, 38 extend through appropriate openings formed in the sidewall of container 12 and are connected to a load 40.

In the use of cell 10, water is added in an appropriate amount as shown by water level 42 in container section 18. When such water is added, it begins to heat owing to the chemical reaction with the composition body 22. As the water heats, it permeates across the barrier 14. Once this water reaches the body 24, electrical current is generated to power the load 40.

Another cell 44 is depicted in FIGS. 2-3. In this case, the cell 44 is a compact, portable device which can be used alone or placed in series with other cells. In detail, the cell 44 has a non-conductive (e.g., cardboard) container 46 which is deformed to present a central recess 48. A first aluminum foil segment 50 is secured to the inner face of the container 46 in conforming relationship to the recess 48 therein; the segment 50 includes a projecting apertured wire 52 serving as one of the electrodes for the cell. A quantity of particulate metal composition 54 is located within the recess 48, in contact with the foil segment 50. An iodine-impregnated, thin polyaniline sheet 56 is disposed over the composition 54 and is in face-to-face relationship with the segment 50 as shown. The sheet 56 is made by cutting conventional polyaniline sheet stock to an appropriate size, and dipping the sheet in finely ground crystalline iodine. A hygroscopic synthetic resin powder 58 is then applied over the sheet 56 to form a very fine layer of powder. Finally, a second segment 60 of aluminum foil is applied to complete the construction of the cell 44. The respective layers of the cell 44 are interconnected using “super glue” or other equivalent adhesive.

In the use of cell 44, electrical leads (not shown) are operatively connected to the wire 52 and the exterior face of foil segment 60. Current is generated when these leads are coupled to a load.

Another exemplary cell 62 is illustrated in FIG. 4. In this case, a rectangular, open top, box-like container 64 is provided, with a POREX central barrier 66 dividing the container into adjacent sections 68, 70. Individual quantities 72, 74 of the elemental metal composition are placed within each of the container sections 68, 70 as shown. Electrodes 76, 78 are embedded within the corresponding composition quantities 72, 74 and are secured in place by conductive clips 80, 82. Wires 84, 86 extend from the clips and are coupled to a load 88. In preferred practice, the electrode 76 is in the form of a ⅛″ diameter aluminum tube, while the electrode 78 is a sheet of commercially available pitch-based carbon fiber.

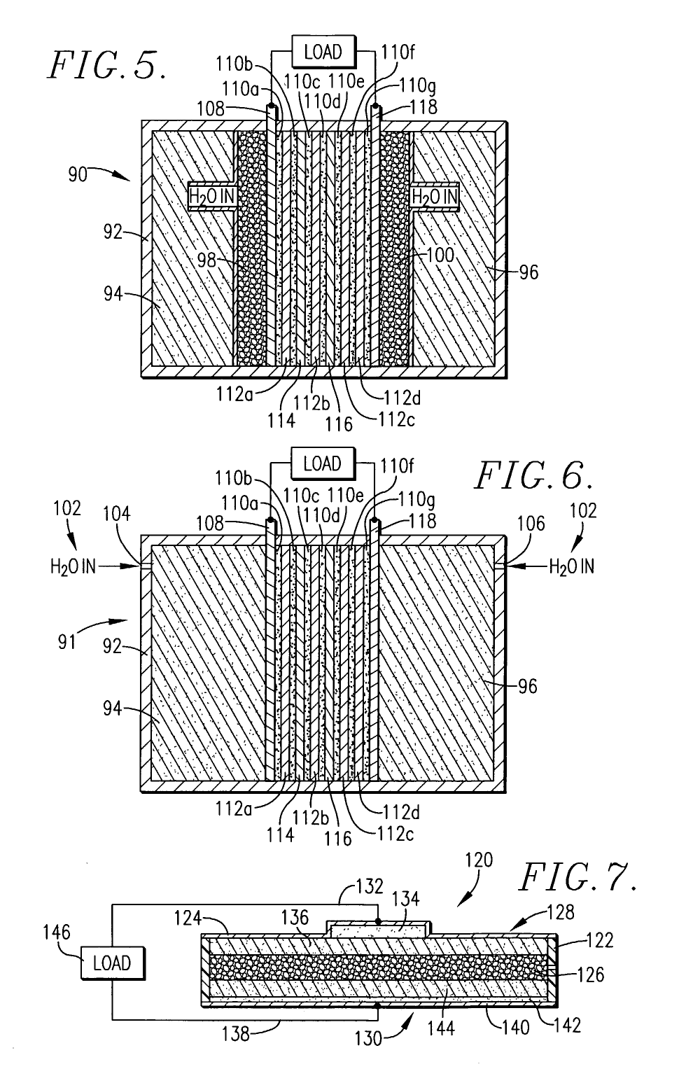

Still other cells 90, 91 are illustrated in FIGS.: 5 and 6. These cells 90, 91 are similar in construction to the embodiment illustrated in FIGS. 2 and 3 and include an electrically conductive layer 92, preferably aluminum foil or the like, surrounding the cells 90, 91. These cells 90, 91 further include a layer of the previously described particulate metal composition 94, 96. Cell 90 also includes a layer of a water-absorbing and retaining polymer 98, 100 which is used a moisture source for the metal composition 94, 96. This polymer layer 98, 100 is not included in cell 91. Therefore the metal composition 94, 96 of cell 91 remains substantially “dry”, receiving only ambient moisture. Alternatively, water, or any electrolytic fluid 102 may be injected into the metal composition 94, 96 through ports 104, 106 passing through the conductive layer 92. In cell 90, an anode 108 is located adjacent the polymer layer 98 followed by respective layers of carbon dust 110a-g, each of which is separated by a layer of polyaniline doped with I₂ crystals 112, a layer of copper oxide 114, or a layer of yttrium barium oxide 116. Layer 110g is located adjacent the cathode 118 followed by the polymer layer 100, and a layer of polymer 96, 98 lying adjacent layer 92. Cell 90 illustrates only one potential arrangement of these successive layers while cell 91 illustrates another potential arrangement. For cell 91, following a layer of metal composition 94, the layers are arranged from the anode 108 to the cathode 118 in the following order: carbon dust 110a- polyaniline 112a- carbon dust 110b- copper oxide 114- carbon dust 110c- polyaniline 112b- carbon dust 110d- yttrium barium oxide 116- carbon dust 110e- polyaniline 112c- carbon dust 110f- polyaniline 112d- carbon dust 110g. As the possible arrangement of these successive layers is not limited, another possible arrangement is provided by cell 91, illustrated in FIG. 6. These layers are arranged in the following order from the anode 108 to the cathode 118: carbon dust 110a- polyaniline 112a- carbon dust 110b- copper oxide 114a- carbon dust 110c- yttrium barium oxide 116a- carbon dust 110d- copper oxide 114b- carbon dust 110e- yttrium barium oxide 116b- carbon dust 110f- polyaniline 112b- carbon dust 110g.

Finally, yet another cell 120 is illustrated in FIG. 7. Cell 120 includes an insulative plastic housing 122 surrounding a thin layer of electrically conductive material 124. A layer of moisture absorbing and retaining polymer 126 is disposed within the enclosed layer of electrically conductive material 124, thereby dividing the cell into two separate sides 128, 130. The first compartment 128 presents an electrode 132 connected to the layer of electrically conductive material 124 followed by a layer of carbon powder or graphite 134 which acts as an electron collector. Layer 134 is followed by a layer 136 of the previously described particulate metal composition which is disposed between the polymer layer 126 and the carbon powder or graphite layer 134. The second side 130 is similar in construction and also presents an electrode 138 connected to a layer of electrically conductive material 140 followed by a layer of carbon or graphite 142, followed by a layer of the particulate metal composition 144 which lies adjacent the polymer 126. A load 146 can then be connected between each electrode 132, 138.

The elemental metal compositions used in the cells of the invention each include a metal fraction having respective quantities of elemental magnesium and elemental iron, together with a very minor amount of alkali metal salt and water in contact with this metal fraction. Advantageously, the magnesium and iron are in particulate form, but may be compressed as illustrated in FIG. 1 to form self-sustaining bodies. The elemental magnesium and iron particulates are most preferably in the form of powders having the approximate size of the corresponding pyrotechnic particles.

The metal fraction of the composition of the invention should include from about 30-90% by weight magnesium, and from about 10-70% by weight iron. More preferably, the magnesium should be used at a level of from about 40-80% by weight while the iron is present at a level of from about 30-70% by weight in the metal fraction. Very satisfactory cells have been produced using about 80% by weight magnesium and 20% by weight iron in the metal fraction. Likewise, advantageous results have been found when using a metal fraction made up of about 50% by weight magnesium. and 50% by weight iron.

The alkali metal salt is preferably mixed with the metal fraction and can be used at a level of from about 0.01-10% by weight of the overall composition, or more preferably from about 0.01-1% by weight. The preferred salt is sodium chloride.

The water fraction of the compositions can be extremely variable. Indeed, a nominally “dry” particulate metal composition including particulate elemental magnesium and particulate elemental iron with a “pinch” of sodium chloride can generate current using only ambient derived moisture from the air. More preferably however, water is added to the composition, generally at a level of from about 0.01-1 cm³ per gram of the metal fraction ofthe composition, more preferably at a level of from about 0.08-0.15 cm³ per gram of the metal fraction of the composition. If desired, a minor amount of alcohol such as methanol, propanol or ethanol (typically up to about 10% by weight of the overall composition) can be added as at least a part of the water for the cell.

Although in no way essential, and indeed tests show that it is unnecessary, the metal fraction may be supplemented with other elemental metals such as those selected from the group consisting of zinc, aluminum and mixtures thereof.

The following examples set forth test results using representative cells in accordance with the invention. It is to be understood, however, that these examples are provided by way of illustration and nothing therein should be taken as a limitation upon the overall scope of the invention.

### Example 1

In this example, a cell as depicted in FIG. 1 was constructed. The PVC container 12 was approximately 6″ in diameter and 12″ in height. The elemental metal composition used to form the self-sustaining bodies 22, 24 was made up of a metal fraction comprising 50% powdered elemental magnesium mill dust and 50% powdered elemental iron mill dust. A tiny amount of sodium chloride was added to the metal fraction and the bodies 22, 24 were press-formed as described previously. These bodies were then suspended using the wires 30-34 within the adjacent sections of the container. In order to initiate the generation of electrical current, approximately 500 ml of water was added to the container section 16, and the wires 36, 38 were connected to a meter. As the water warmed owing to the reaction of the metal composition within the section 16, the water permeated across the barrier 14. As soon as this water contacted the composition body 24, electrical current was generated.

### Example 2

In this test, the packet-type cell illustrated in FIGS. 3 and 4 was constructed and tested. The metal fraction of the particulate metal composition used was made up of 50% by weight magnesium, 20% by weight iron and 30% by weight zinc, where all ofthe metals were elemental metal mill dust. 0.2 ounce of this metal fraction was used, together with a trace of sodium chloride and about 0.4 ounce of finely divided powdered carbon and a few drops of water. This homogeneous mixture was retained within the cell 44 as explained above. In this test, the cell generated a voltage of about 6 volts with a current of about 25-35 amps for a period of 30 minutes.

### Example 3

In this case, a cell 62 depicted in FIG. 4 was constructed. One-quarter pound of a metal fraction containing 80% by weight magnesium mill dust powder and 20% by weight iron mill dust powder was prepared, and a trace of sodium chloride was added. 220 cm³ of water was added to complete the composition, and the latter was placed within the container 64 on opposite sides of the barrier 66. The electrodes 76 and 78 were next positioned using the clips 80, 82, and a meter 88 was connected to the wires 84, 86. This cell generated a voltage of 8.2 volts and a current of 3 amps for approximately 6 hours. During the course of the test, hydrogen was evolved from the composition.

In another test using this cell, the composition included a metal fraction made up of 50% by weight elemental iron mill dust and 50% by weight elemental magnesium mill dust, with a trace of sodium chloride added thereto. This mixture was placed within the cell without moisture addition, which generated a current of about 0.5 amps and 8 volts. Thus, the nominally “dry” composition was capable of generating current, owing to absorption of water from the atmosphere. In the next step, a liquid mixture made up of 20 cm³ water and 50 cm³ of commercially purchased alcohol-containing bath gel was added to the remaining ingredients of the composition. This liquid was added in equal quantities to both sections 68, 70 of the cell container. After mixing to promote homogeneity, the cell generated 8 amps and about 12 volts. The duration of current generation was approximately 3 days.

I claim:

1. An electrical cell comprising an elemental metal composition and a pair of spaced apart electrodes operatively coupled with said composition for generation of electrical current, said composition including a metal fraction having respective quantities of elemental magnesium and elemental iron, with an alkali metal salt and water in contact with the metal fraction.

2. The cell of claim 1, said elemental magnesium and elemental iron being in particulate form.

3. The cell of claim 2, said particulate elemental magnesium and particulate elemental iron being compressed together to form a self-sustaining body.

4. The cell of claim 2, said magnesium and iron being in the form of powders.

5. The cell of claim 4, said powders being approximately the size of pyrotechnic particles.

6. The cell of claim 1, said metal fraction of said composition including from about 30-90% by weight magnesium and from about 10-70% by weight iron.

7. The cell of claim 6, said metal fraction of said composition including from about 40-80% by weight magnesium and from about 30-70% by weight iron.

8. The cell of claim 6, said metal fraction of said composition including about 80% by weight magnesium and about 20% by weight iron.

9. The cell of claim 6, said metal fraction of said composition including about 50% by weight magnesium and about 50% by weight iron.

10. The cell of claim 1, said alkali metal salt being present at a level of from about 0.01-10% by weight.

11. The cell of claim 10, said alkali metal salt being present at a level of from about 0.01-1% by weight.

12. The cell of claim 1, said water being present at a level of from about 0.01-1 cm³ water per gram of said metal fraction of said composition.

13. The cell of claim 12, said level being from about 0.08-0.15 cm³ water per gram of said metal fraction of said composition.

14. The cell of claim 1, said metal fraction further including an elemental metal selected from the group consisting of zinc and aluminum and mixtures thereof.

15. The cell of claim 1, including a container for said composition, said container including a moisture-permeable barrier therein dividing the container into adjacent sections, said composition divided into two quantities, each of said container sections housing one of said composition quantities.

16. The cell of claim 1, said water derived from ambient atmosphere.

17. The cell of claim 1, said water being added to said cell for contacting said metal fraction and alkali metal salt.

18. The cell of claim 1, said alkali metal salt being sodium chloride.

19. The cell of claim 1, said electrodes being coupled with a load.

20. The cell of claim 1, said cell further comprising a water absorbent polymer in fluid communication with said metal fraction.

21. The cell of claim 20, said polymer comprising a polymer selected from the group consisting of sodium or potassium based cross-linked polymers.

22. The cell of claim 21, said polymer comprising a potassium based cross-linked polymer.

23. The cell of claim 1, said cell further comprising respective layers selected from the group consisting of polyaniline doped with I₂ crystals, plastic mylar, plastic mylar with a metal coating, copper oxide, and yttrium barium oxide, each of said respective layers having therebetween a layer selected from the group consisting of carbon dust, graphite, and combinations thereof.

24. The cell of claim 23, said respective layers including at least one polyaniline layer, one copper oxide layer, and one yttrium barium oxide layer.

25. The cell of claim 23, said respective layers being in particulate form.

26. The cell of claim 20, said cell further comprising at least one collector layer selected from the group consisting of carbon powder and graphite.

27. The cell of claim 26, said polymer being centrally located in said cell, said composition being on both sides of said polymer and one of said collectors being located adjacent said composition and in electrical contact with said electrodes.

28. The cell of claim 1, said cell being re-chargable.

29. An electrical cell comprising:
a container comprising a generally flat non-conductive body presenting a recess;
a first segment of conductive metallic foil disposed over at least a portion of said container;
a quantity of a metal composition within said recess and operatively coupled with said foil, said composition including a metal fraction having respective quantities of elemental magnesium and elemental iron, with an alkali metal salt and water in contact with the metal fraction;
a non-conductive barrier sheet disposed over said composition and adjacent portions of said first segment of metallic foil; and
a second segment of conductive metallic foil adjacent said barrier sheet,
said container, first segment, barrier sheet and second segment being joined together with said composition captively retained within said recess,
said first and second segments operatively coupled with said composition and defining respective electrodes.

30. The cell of claim 29, said elemental magnesium and elemental iron being in particulate form.

31. The cell of claim 30, said particulate elemental magnesium and particulate elemental iron being compressed together to form a self-sustaining body.

32. The cell of claim 30, said magnesium and iron being in the form of powders.

33. The cell of claim 32, said powders being approximately the size of pyrotechnic particles.

34. The cell of claim 29, said metal fraction of said composition including from about 30-90% by weight magnesium and from about 10-70% by weight iron.

35. The cell of claim 34, said metal fraction of said composition including from about 40-80% by weight magnesium and from about 30-70% by weight iron.

36. The cell of claim 34, said metal fraction of said composition including about 80% by weight magnesium and about 20% by weight iron.

37. The cell of claim 34, said metal fraction of said-composition including about 50% by weight magnesium and about 50% by weight iron.

38. The cell of claim 29, said alkali metal salt being present at a level of from about 0.01-10% by weight.

39. The cell of claim 38, said alkali metal salt being present at a level of from about 0.01-1% by weight.

40. The cell of claim 29, said water being present at a level of from about 0.01-1 cm³ water per gram of said metal fraction of said composition.

41. The cell of claim 40, said level being from about 0.08-0.15 cm³ water per gram of said metal fraction of said composition.

42. The cell of claim 29, said metal fraction further including an elemental metal selected from the group consisting of zinc and aluminum and mixtures thereof.

43. The cell of claim 29, said water being added to said cell for contacting said metal fraction and alkali metal salt.

44. The cell of claim 29, said alkali metal salt being sodium chloride.

45. The cell of claim 29, said electrodes being coupled with a load.

46. The cell of claim 29, said cell further comprising a water absorbent polymer in fluid communication with said metal fraction.

47. The cell of claim 46, said polymer comprising a polymer selected from the group consisting of sodium or potassium based cross-linked polymers.

48. The cell of claim 47, said polymer comprising a potassium based cross-linked polymer.

49. The cell of claim 29, said cell further comprising respective layers selected from the group consisting of polyaniline doped with I₂ crystals, plastic mylar, plastic mylar coated with metal, copper oxide, and yttrium barium oxide, each of said respective layers having therebetween a layer selected from the group consisting of carbon dust, graphite, and combinations thereof.

50. The cell of claim 49, said respective layers including at least one polyaniline layer, one copper oxide layer, and one yttrium barium oxide layer.

51. The cell of claim 49, said respective layers being in particulate form.

52. The cell of claim 46, said cell further comprising at least one collector layer selected from the group consisting of carbon powder and graphite.

53. The cell of claim 52, said polymer being centrally located in said cell, said composition being on both sides of said polymer and one of said collectors being located adjacent said composition and in electrical contact with said electrodes.

54. The cell of claim 29, said cell being re-chargable.

55. A method of generating electrical current comprising the steps of:
providing an elemental metal composition including a metal fraction having respective quantities of elemental magnesium and elemental iron, with an alkali metal salt and water in contact with the metal fraction;
coupling a pair of electrodes to said composition in electrically separate relationship to each other;
connecting said electrodes to, a load; and
allowing said composition to react to generate an electrical current.

56. The method of claim 55, said elemental magnesium and elemental iron being in particulate form.

57. The method of claim 56, said particulate elemental magnesium and particulate elemental iron being compressed together to form a self-sustaining body.

58. The method of claim 56, said magnesium and iron being in the form of powders.

59. The method of claim 58, said powders being approximately the size of pyrotechnic particles.

60. The method of claim 55, said metal fraction of said composition including from about 30-90% by weight magnesium and from about 10-70% by weight iron.

61. The method of claim 60, said metal fraction of said composition including from about 40-80% by weight magnesium and from about 30-70% by weight iron.

62. The method of claim 60, said metal fraction of said composition including about 80% by weight magnesium and about 20% by weight iron.

63. The method of claim 60, said metal fraction of said composition including about 50% by weight magnesium and about 50% by weight iron.

64. The method of claim 55, said alkali metal salt being present at a level of from about 0.01-10% by weight.

65. The method of claim 64, said alkali metal salt being present at a level of from about 0.01-1% by weight.

66. The method of claim 55, said water being present at a level of from about 0.01-1 cm³ water per gram of said metal fraction of said composition.

67. The method of claim 66, said level being from about 0.08-0.15 cm³ water per gram of said metal fraction of said composition.

68. The method of claim 55, said metal fraction further including an elemental metal selected from the group consisting of zinc and aluminum and mixtures thereof.

69. The method of claim 55, including a container for said composition, said container including a moisture-permeable barrier therein dividing the container into adjacent sections, said composition divided into two quantities, each of said container sections housing one of said composition quantities.

70. The method of claim 55, said water derived from ambient atmosphere.

71. The method of claim 55, said water being added to said cell for contacting said metal fraction and alkali metal salt.

72. The method of claim 55, said alkali metal salt being sodium chloride.

73. The method of claim 55, said electrodes being coupled with a load.

74. The method of claim 55, said cell further comprising a water absorbent polymer in fluid communication with said metal fraction.

75. The method of claim 74, said polymer comprising a polymer selected from the group consisting of sodium or potassium based cross-linked polymers.

76. The method of claim 75, said polymer comprising a potassium based cross-linked polymer.

77. The method of claim 74, said cell further comprising respective layers selected from the group consisting of polyaniline doped with I₂ crystals, plastic mylar, plastic mylar with a metal coating, copper oxide, and yttrium barium oxide, each of said respective layers having therebetween a layer selected from the group consisting of carbon dust, graphite, and combinations thereof.

78. The method of claim 77, said respective layers including at least one polyaniline layer, one copper oxide layer, and one yttrium barium oxide layer.

79. The method of claim 77, said respective layers being in particulate form.

80. The method of claim 74, said cell further comprising at least one collector layer selected from the group consisting of carbon powder and graphite.

81. The method of claim 80, said polymer being centrally located in said cell, said composition being on both sides of said polymer and one of said collectors being located adjacent said composition and in electrical contact with said electrodes.

82. The method of claim 55, said cell being re-chargable.
